(19) United States
(12) Patent Application Publication
(10) Pub. No.: US 2026/0170475 A1
(43) Pub. Date: Jun. 18, 2026

(54) SYSTEMS AND METHODS FOR USE IN ENHANCED BIOMETRIC AUTHENTICATION

(71) Applicant: MASTERCARD INTERNATIONAL INCORPORATED, PURCHASE, NY (US)

(72) Inventors: Christopher Paul KENDALL, Leighton Buzzard (GB); Alan WANG, Chesterfield, MO (US); Edward Neil LIVINGSTON, Dunfermline (GB); Mark Robert BRITTEN, Kilmalcolm (GB); Mayur BharatKumar THACKER, Pune, IN (US); Nuro CARVALHO, Carnaxide (PT)

(21) Appl. No.: 19/413,550

(22) Filed: Dec. 9, 2025

Related U.S. Application Data
(60) Provisional application No. 63/896,639, filed on Oct. 9, 2025.

(30) Foreign Application Priority Data
Dec. 14, 2024 (IN) 202411098993

(51) Int. Cl. G06Q 20/20; G06Q 20/38

(52) U.S. Cl. CPC G06Q 20/206; G06Q 20/3821

(57) ABSTRACT

Systems and methods are provided for enhanced biometric authentication, based on proximity of mobile devices. One example computer-implemented method includes, for a biometric-initiated transaction, receiving an authentication request from a first party, where the authentication request includes a biometric specific to a user and captured at a point-of-sale (POS) terminal at the first party and a listing of token(s) and identifier(s). The method also includes identifying a biometric template based on the identifier, and identifying a device ID of a mobile device based on the token(s). The method further includes verifying that the device ID is bound to the identifier(s), compiling a response to the authentication request, and providing a transaction payload for the transaction to a payment service provider (PSP).

### CROSS-REFERENCE TO RELATED APPLICATIONS

This application claims the benefit of, and priority to, Indian Patent Application No. 202411098993, filed on Dec. 14, 2024, and U.S. patent application Ser. No. 63/896,639, filed on Oct. 9, 2025. The entire disclosure of each of the above applications is incorporated herein by reference.

### FIELD

The present disclosure generally relates to systems and methods for use in enhanced biometric authentication, based on proximity of mobile devices.

### BACKGROUND

This section provides background information related to the present disclosure which is not necessarily prior art.

Users are known to initiate interactions with parties in various manners. For example, a user (e.g., a consumer, etc.) may present a physical card, or other device, to a first party, to initiate payment from an account associated therewith to purchase a good or service from the first party. The card or other device is tied to the account, whereby associated information is delivered from the card or other device (e.g., an account number, etc.) to the first party to initiate the payment to purchase the good or service. More recently, the user is permitted to present a biometric, in lieu of the card or other device, to initiate the interaction to an account linked to the biometric.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in facilitating biometric-enabled network interactions;

FIG. 2 is a block diagram of an example computing device that may be used in the system of FIG. 1;

FIG. 3 is a flow diagram of an example method, which may be implemented in connection with the system of FIG. 1, for enrolling a user for biometric interactions;

FIG. 4 is a flow diagram of an example method, which may be implemented in connection with the system of FIG. 1, for initiating a biometric interaction;

FIG. 5 illustrates multiple example interfaces, which may be employed in connection with the system of FIG. 1 and/or the method of FIG. 3;

FIG. 6 illustrates multiple example interfaces, which may be employed in connection with the system of FIG. 1 and/or the method of FIG. 4;

FIG. 7 is a flow diagram of another example method, which may be implemented in connection with the system of FIG. 1, for enrolling a user for biometric interactions;

FIG. 8 illustrates multiple example interfaces, which may be employed in connection with the system of FIG. 1 and/or the method of FIG. 7; and

FIG. 9 is a flow diagram of another example method, which may be implemented in connection with the system of FIG. 1, for initiating a biometric interaction.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Biometric interactions provide for enhanced convenience at checkout, where a biometric is used, in lieu of a card device or other device indicative of an account. As the prevalence of accounts, and consequently, biometrics, continues to grow, processing involved in matching the biometrics (e.g., biometric templates representative of the biometrics, etc.) to a reference biometric, to the exclusion of other reference biometrics, becomes substantial, in terms of elapsed time, processing resources, and network performance, etc. The processing, however, may be limited, or avoided, in some situations, where the advent of additional data reduces the number of potential matching reference biometrics, which is not conventionally available.

Uniquely, the systems and methods herein leverage a secure session ID, which is signed by a mobile device associated with a user, or a device specific token, along with a captured biometric (or template thereof) for the user, to identify a biometric identifier. In doing so, the systems and methods further provide for multi-factor authentication of the user.

In particular, in one implementation, in connection with a biometric interaction, a point-of-sale (POS) terminal requests a session ID from a biometric service provider (BSP), which is provided to the POS terminal. The POS terminal then wirelessly broadcasts the session ID in the immediate proximity of the POS terminal. The mobile device of one or more enrolled users (in the vicinity of the POS terminal (e.g., within five feet, ten feet, thirty feet, etc.), etc.) captures the session ID and signs it with a key specific to the mobile device (e.g., a private key, etc.). The mobile device then provides the signed session ID back to the POS terminal, which includes the same in a request to the BSP to resolve the biometric template captured by the POS terminal. The BSP validates the signature of the session ID, using a corresponding key (e.g., a public key, etc.), and only searches for a reference biometric to match based on a user(s) associated with the corresponding key.

In another implementation, the mobile device is leveraged as a restricted mechanism to retrieve a device specific token, which is then linked to the specific mobile device of the user, as defined during enrollment/registration. When the enrolled/registered mobile device is in the range of the POS terminal, the POS terminal responds with a device specific token and a biometric ID, which is provided to the BSP. The BSP matches the biometric to a specific user, through use of the biometric ID and/or the token (thereby limiting the pool of potential matching biometrics). The biometric ID and the device are verified as being bound together during enrollment and/or registration, whereby the user is identified and authenticated.

In this manner, processing resources required to locate a matching reference biometric are reduced. That is, the matching of a limited number of reference biometrics, as compared to all available reference biometrics at the BSP, is substantial and may be avoided by way of the present disclosure. What's more, the signed session ID originates at the mobile device of the user, or the token is specific to the mobile device of the user, which is present at the POS terminal, whereby the biometric in combination with the signed session ID or the token provides two-factor authentication of the user in connection with the biometric interaction.

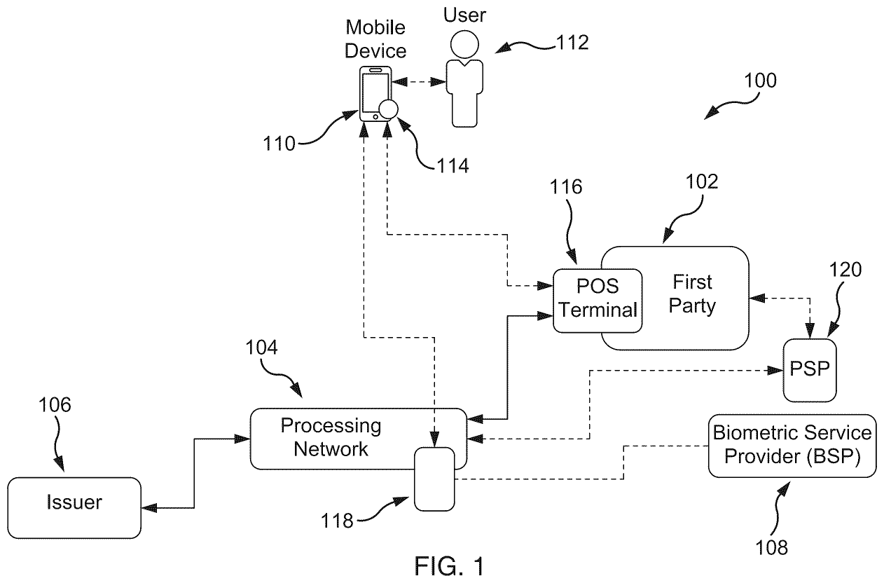

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between parties in the system 100, features of biometric interactions, privacy rules and regulations, etc.

As shown in FIG. 1, the illustrated system 100 generally includes a first party 102, a processing network 104, an issuer 106, a biometric service provider (BSP) 108, and a payment service provider (PSP) 120, each of which is coupled to (and is in communication with) one or more network(s) (as indicated by the arrowed lines in FIG. 1). The one or more network(s) may each include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, one network may include a private payment network made accessible by the processing network 104 to the issuer 106 and, separately, the public Internet, which may provide interconnection between one or more of the first party 102 and a mobile device 110 associated with a user 112, etc.

The first party 102 of the illustrated system 100, in general, offers products (e.g., goods, services, etc.) for sale and/or sells products to users, including the user 112 (whereby, in this example, the first party 102 may be a merchant, etc.). In this example embodiment, the first party 102 includes either a brick-and-mortar store (e.g., a physical store location, etc.) or a virtual merchant location, such as, for example, a website, network-enabled application, etc. In either instance, the first party 102 permits, through the location, the user 112, for example, to browse products and to purchase products.

As shown in FIG. 1, the first party 102 includes a point-of-sale (POS) terminal 116 which, among other things, is configured to compile and transmit authorization messages for interactions funding the purchase of products from the first party 102. As illustrated in FIG. 1, the POS terminal 116 is generally disposed at the first party 102. The POS terminal 116 also includes a biometric capturing device (not shown), which is configured to capture a biometric of users, including the user 112, etc. The biometric capturing device may include, for example, a camera (e.g., a camera device to take a biometric scan of a face, a hand, a finger, a palm, etc.), a fingerprint, palm or retina scanner, or other input device, etc. The biometric capturing device may be included physically within, or at least partially within, the POS terminal 116, or may be separate therefrom, or connected (wired, wirelessly, etc.) to the POS terminal 116, etc. That said, the biometric capturing device may be apart of another device, which is in communication with the POS terminal 116. For example, the biometric capturing device may include a camera or other sensor of a mobile device of a user, where the mobile device is in communication with the first party 102 and/or the POS terminal 116.

Further, the first party 102 is associated with at least one of an acquirer (not shown) and the PSP 120, through which the first party 102 is configured to request authorization for transactions. The acquirer and/or PSP 120 is configured, in turn, to communicate authorization requests to the issuer 106, through the processing network 104. In addition in the illustrated system 100, the issuer 106 is associated with the user 112, and is configured to issue an account (e.g., a debit account, a credit account, a prepaid account, a checking account, etc.) to the user 112 to use in funding interactions, including with the first party 102. It should be appreciated that the issuer 106 may be configured to issue multiple accounts to the user 112, and/or the user 112 may be issued accounts from other issuers in communication with the processing network 104.

With continued reference to FIG. 1, the processing network 104 may be employed for purposes of authentication and authorization. In one example, the processing network 104 includes, specifically, a payment processing network, such as the MASTERCARD, VISA, or DISCOVER, etc., payment processing networks.

It should be appreciated that the processing network 104 may be configured for additional functions consistent with the description herein. Specifically, for example, the processing network 104 may be configured to act as a check out service for the first party 102. In connection therewith, the processing network 104 is configured to retrieve account credentials for tokens provided thereto and also initiate account transactions based on transaction payloads, for example, with the PSP 120. The PSP 120, as shown in FIG. 1, is configured to facilitate transactions as an (and/or with an) acquirer institution (e.g., banks, credit unions, etc.) associated with the first party 102 and the issuer 106, for accounts issued by issuer 106.

That said, in this example, the processing network 104 is configured consistent with one or more enhanced authentication schemes, such as, for example, the EMV 3DS protocol (see, e.g., www.emvco.com/emv-technologies/3d-secure/ (which is incorporated herein by reference), etc.). In particular, the processing network 104 may include a 3DS server and a directory server. The 3DS server may be incorporated in and/or associated with the first party 102, whereby reference herein to the first party 102 and the 3DS server may be interchangeable, except where explicitly distinct. The directory server is associated with or, in this example, included in the processing network 104 (e.g., MASTERCARD, VISA, DISCOVER, etc., processing networks, etc.) and is configured as described below. It should be appreciated that the processing network 104 may further include an access control server (ACS), which is incorporated in and/or is part of the issuer 106.

In this example embodiment, the processing network 104 is further configured to coordinate messaging between the PSP 120 (or the acquirer institution of the first party 102) and the issuer 106 to provide authorization of interactions, whereby the user 112 funds the purchase of one or more products, by and between the account of the user 112 and an account of the first party 102. In this manner, the processing network 104 is configured to enable communication, via the International Standard Organization (ISO) 8583 standard, or ISO 20022 standard, between the issuer 106 and the PSP 120/acquirer, etc.

With continued reference to FIG. 1, the mobile device 110 is associated with the user 112 and may include any suitable device. In this example embodiment, the mobile device 110 is illustrated as a smartphone. That said, the mobile device 110 may be a different device (either mobile or not) in other embodiments, including, for example, a laptop computing device, a tablet device, a smartwatch device, a desktop computing device, or other device, etc. As further shown in FIG. 1, the mobile device 110 includes an application 114, which configures the mobile device 110 to operate as described herein. The application 114 may include a financial application, or other application, which may be provided by, or associated with, the first party 102, the processing network 104, the issuer 106, the BSP 108, or another entity included in, or not, the system 100, etc.

With continued reference to FIG. 1, the user 112 may desire to be enrolled in biometric interactions with the first party 102 and potentially other first parties. In this way, the user 112 would be permitted to present a biometric, in lieu of a card or other device, etc. to purchase product(s) from the first party 102, through a designated payment account.

Based on the above, the first party 102 is associated with the BSP 108. The BSP 108 is configured to enable the first party 102 to participate in biometric interactions and further to participate in enrollment of users (e.g., the user 112, etc.) for biometric interactions. In general, the BPS 108 is configured to receive and to store biometric template(s) for user in connection with enrollment. The BSP 108 is further configured to receive a biometric for a biometric interaction from the first party 102, for example, and to perform biometric matching for the biometric interaction to identify the user, based on the biometric templates, from different users, including the user 112. It should be appreciated that the BSP 108 may be standalone, as shown in FIG. 1, or integrated, in whole or in part, with another part of the system 100 (e.g., included in the processing network 104, etc.). In this example embodiment, the system 100 also includes an authentication service platform 118, which may be a standalone computing device, or integrated into another computing device. As shown, for example, in FIG. 1, the authentication service platform 118 may be included, in whole or in part, in the processing network 104, the BSP 108, or other parties/devices of FIG. 1. For purposes of the description herein, the authentication service platform 118 is described as including the BSP 108 (as shown by the dotted line), but again the BSP 108 may be included alone or elsewhere in other embodiments. For example, the BSP 108 may be a stand alone entity, but communicate with the remainder of the system 100 through the authentication service platform 118.

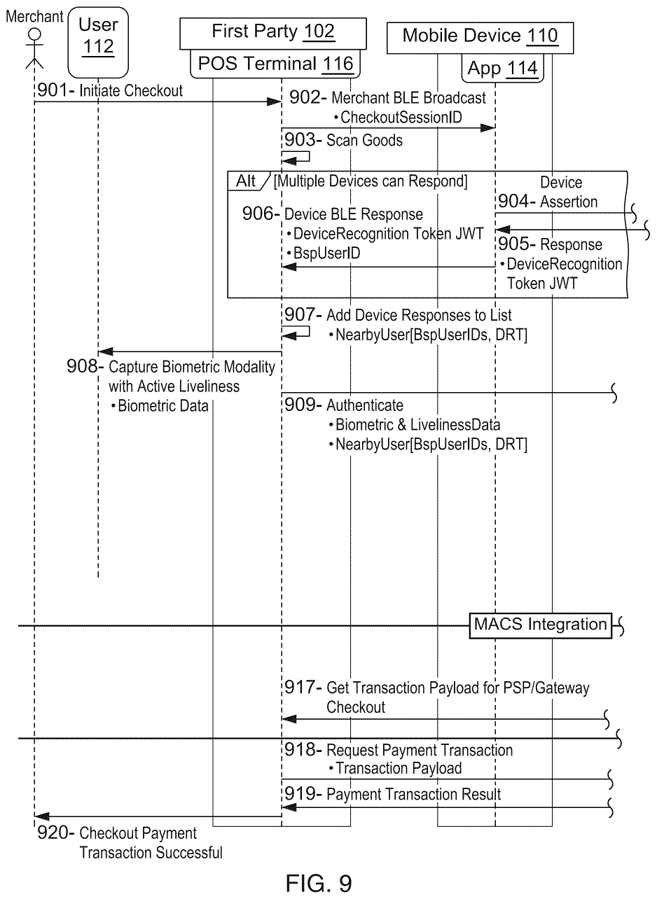

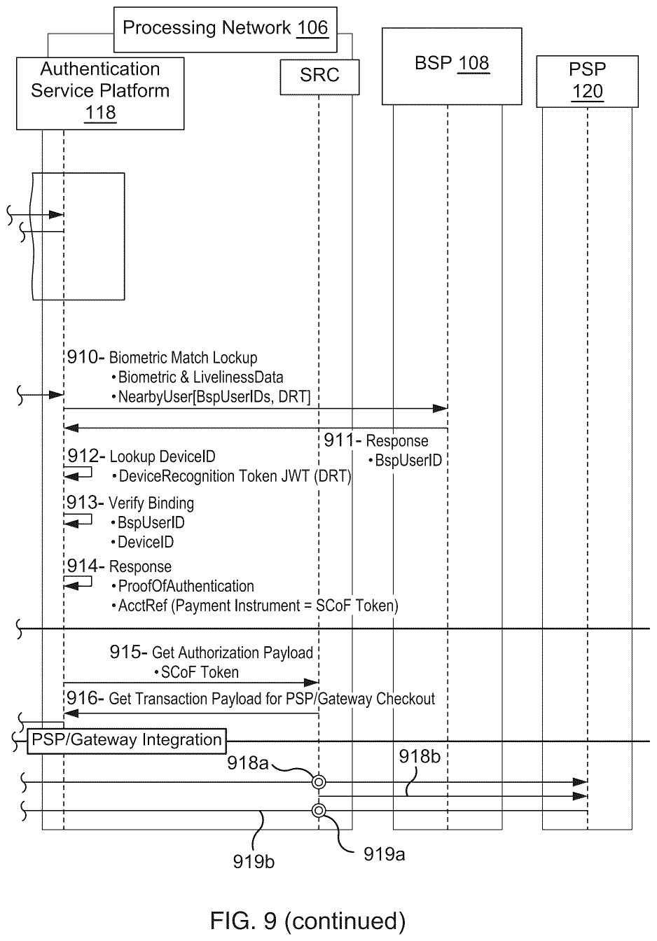

That said, it should be appreciated that in example embodiments, the processing network 104 may include a biometric checkout service (BCS) (e.g., for managing biometric checkout for interactions, etc.) configured to manage end-to-end user experience, enrollment of devices, management of biometrics and payment instruments, and/or perform identification/authentication logic, and/or then also proceed in a checkout flow to a payment transaction. The BCS (note shown) may be a part of the processing network 104 or it may be a standalone part of the system 100. In any case, in such examples, the BCS may include, or may be configured to perform one or more functions described herein as being performed by, the authentication service platform 118, the BSP 108, the PSP 120, the SRC (i.e., the secure remote commerce service (embodied in a computing device) as shown in FIG. 9), or a combination thereof, etc.

Given the above, for enrollment for biometric interactions, for example, the user 112 decides to enroll for biometric interactions at the mobile device 110. In connection therewith, the mobile device 110 is configured to communicate with the BSP 108, through the authentication service platform 118. This communication may be direct, or through a software development kit (SDK) from the authentication service platform 118 and/or the BSP 108. In such an example, the SDK is included in the application 114, whereby the user 112 downloads the application 114 to the mobile device 110 (if not already included in the mobile device 110), launches the application 114, and selects to enroll for biometric interactions at the first party 102, through the authentication service platform 118 and/or the BSP 108, whereby the mobile device 110 is configured by the application 114 (and/or SDK therein) to perform as described herein.

In turn, as part of enrollment, the mobile device 110, as configured by the application 114, captures a biometric of the user 112. The biometric may include, without limitation, an image of scan of the user's face (e.g., facial image, etc.), fingerprint, palm, etc.

Also, the user 112 is solicited, by the mobile device 110, to input an account to be used with the biometric. In connection therewith, the mobile device 110 is configured, by the application 114, to initiate an identification and verification (ID&V) process with the issuer 106 of that card account, whereby the issuer 106 is configured to solicit information sufficient from the user 112, via the mobile device 110, or otherwise, to identify the user 112 and then further to verify the identity of the user 112 (in connection with other parts of the system 100 or still other parts), which ensures that the user 112 is in fact the person to which the account is issued, and potentially, also permitted to use the account in the manner requested. For example, the mobile device 110 is configured, by the application 114, to interact with the issuer 106 to seek permission for enrollment. The issuer 106, in turn, is configured to participate in an authentication of the user 112 (as the user requesting the enrollment at the mobile device 110), in general or, for example, through a 3DS interaction (e.g., as indicated in the EMV 3-D Secure (EMV 3DS) standard, etc.) to the user 112 (e.g., challenge question, etc.).

When verified, the mobile device 110 is configured, by the application 114, to generate a private-public key pair, based on one or more cryptographic algorithms, and to store the private key in a secure memory of the mobile device 110 (e.g., a trusted platform module (TPM), a trusted execution element (TEE), etc.). The mobile device 110 is further configured, by the application 114, to share the public key with the authentication service platform 118 and/or the BSP 108. Also, the mobile device 110 is configured, by the application 114, to request a challenge from the BSP 108 (through the authentication service platform 118). In response, the BSP 108 is configured to generate a challenge, which may include, for example, a string of random characters, etc. The BSP 108 is configured to then return (through the authentication service platform 118) the challenge to the mobile device 110. The mobile device 110 is configured to sign the challenge with the private key from the secure memory and to submit, to the authentication service platform 118, an enrollment request (or registration request), which includes the captured biometric (or template thereof), a biometric ID, the public key (if not already provided), a credential from the account, the signed challenge and the public key, etc.

The authentication service platform 118, in turn, is configured to validate the public key with the BSP 108. In particular, the authentication service platform 118 is configured to provide the signed challenge, and the public key (if not provided already), to the BSP 108, along with the captured biometric (or template thereof) and biometric ID. The BSP 108, in turn, is configured to verify the signature on the challenge based on the public key (e.g., the public key is a valid generated certificate based on the operating system of the mobile device 110, etc.). Once verified, the BSP 108 is configured to create a mapping between the public key, the captured biometric (or template thereof), and the biometric ID and to store the same in memory thereof.

When the validation is complete, the authentication service platform 118 is further configured to bind the biometric ID, the card account and the public key and to store the same in memory thereof.

In connection with the above, the mobile device 110, as configured by the application 114, displays an interface, or dashboard, to the user 112, which indicates the successful enrollment of the biometric of the user 112 for use in biometric interactions.

It should be understood that the communication between the mobile device 110 and the authentication service platform 118 and/or the BSP 108, may be through one or more APIs (e.g., exposed by the authentication service platform 118, the BSP 108, etc.), or based on a software development kit (SDK) sponsored by the authentication service platform 118 and/or the BSP 108 and included in the application 114. It should be appreciated that other techniques for communication therebetween may be employed in other system embodiments.

Additionally, or alternatively, in connection with enrollment/registration through the application 114, the mobile device 110 is configured to solicit and receive, from the user 112, identifying data for the user 112, where the identifying data may include, without limitation, a name, an email address and/or a mobile phone number, a physical address, etc. In response, the mobile device 110 may be configured to initiate, alone or in combination with a backend, an identify and verify (ID&V) process, which may be consistent or inconsistent with the description above. For example, the mobile device 110 may be configured to participate in a one-time-passcode (OTP) verification, which is initiated through the authentication service platform 118 (or the issuer 106) to the mobile device 110, and submitted back to the authentication service platform 118 upon receipt at the mobile device 110.

The mobile device 110 is further configured to capture a biometric and a PIN from the user 112. The mobile device 110 is also configured to interact with one or more issuers, including the issuer 106, to permit the user 112 to add one or more payment accounts for use in biometric interactions.

Further, in this example embodiment, the mobile device 110 is configured to then transmit an attestation assertion request to the authentication service platform 118. The attestation assertion request includes a certain data (e.g., device ID, etc.) and a signature specific to the mobile device 110 (e.g., based on a private key included therein, etc.). In response, the authentication service platform 118 is configured to verify the attestation assertion request based on a corresponding public key (or otherwise) and to generate a device recognition token (DRT) (e.g., specific to the mobile device 110 (e.g., based on the device ID, mobile number, etc.), etc.) and to return the DRT to the mobile device 110.

Further, the mobile device 110 is configured to submit the biometric of the user 112 to the BSP 108 (either directly or through the authentication service platform 118) as a request for a biometric ID for the biometric to be provided. It should be appreciated that the request includes an indication of the one or more checks performed in capturing the biometric (e.g., the liveness detection, etc.). In response, the BSP 108 is configured to validate the biometric and check(s), to generate a biometric ID (also referred to herein as a bspUserID), to bind the biometric to the biometric ID in memory thereof, and then to issue the biometric ID for the biometric to the user 112. In turn, the mobile device 110 is configure to register the user 112 and mobile device 110 with the authentication service platform 118. The registration data includes the user profile (e.g., name, mobile number, email address, device ID for the mobile device 110, etc.), the biometric ID, the payment account(s) and the DRT.

In response, the authentication service platform 118 is configured to validate the DRT. The validation may include, for example, matching the received DRT to the DRT previously generated and provided to the mobile device 110, and/or based on specific key-based signatures, etc. The matching may be based on, for example, the device ID associated with the mobile device 110 and included in the registration data, etc. When the DRT is validated, the authentication service platform 118 is configured to bind the user profile (including the device ID for the mobile device 110), the biometric ID, the payment account, and the DRT. Finally, once bound, the authentication service platform 118 is configured to confirm the registration/enrollment to the mobile device 110.

Subsequently, in one or more embodiments, the user 112 travels to first party 102 to purchase one or more products, etc., whereupon, at checkout, the user 112 selects, at the POS terminal 116, to initiate a biometric interaction with the first party 102 to fund the purchase of the one or more products.

In response, the POS terminal 116 is configured to request a session ID for the interaction from the BSP 108, via the authentication service platform 118. In turn, the BSP 108 is configured to generate a unique session ID for the interaction and to return the session ID to the POS terminal 116. Upon receipt of the session ID, the POS terminal 116 is configured to broadcast the session ID. In particular, the POS terminal 116 is configured to broadcast, via a Bluetooth LE (BLE) protocol (e.g., in the 2.400-2.4835 GHz ISM band, etc.), Ultra Wide Band (UWB) (e.g., in the 3.1-10.6 GHz ISM band, etc.), etc., to the mobile devices within a range of the broadcast. The range of the broadcast may be up to about 30 meters, or up to about 100 meters, less than about 200 meters, etc. (where about includes ±10%). That said, other ranges may be applicable for other types of wireless network communications, etc.

In this example embodiment, the mobile device 110 is within the range of the POS terminal 116, and consequently, the mobile device 110, as configured by the application 114, receives the session ID (because it is enrolled). The mobile device 110, as configured by the application 114, then signs the session ID with the private key from the secure memory thereof and returns the signed session ID to the POS terminal 116. The session ID, because it is signed, includes metadata specific to the mobile device 110.

Given the range of the broadcast, it is possible that one or more additional mobile devices, similar to the mobile device 110, received the session ID. Each, consequently, as configured by the application 114, also signs the session ID with the private key specific to that mobile device and returns the signed session ID to the POS terminal 116. It should be appreciated that each signature is distinct because each of the mobile devices has its own, unique private key.

Upon receipt of the signed session ID, or prior to or at the same time as receipt, etc., the POS terminal 116 is configured to capture a biometric of the user 112. The POS terminal 116 is configured to then transmit a request to the authentication service platform 118 to resolve the biometric, where the request includes the biometric and each of the signed session IDs. In this example, the biometric refers to one or both of the captured biometric or a biometric templates, which is representative of the captured biometric. Again, the biometric may include an image or scan of the face, fingerprint, palm, etc., of the user 112.

In response to the request, the authentication service platform 118 is configured to cooperate with the BSP 108, to assess the signature for each of the session IDs. In particular, in this example, for the signed session ID from the mobile device 110, the authentication service platform 118 is configured to identify, for the signed session ID (e.g., signature, etc.), from the metadata, the mobile device 110 that signed the session ID. The metadata may include a specific identifier or other information, from which the authentication service platform 118 and/or the BSP 108 is configured to identify a public key specific to the mobile device 110. The authentication service platform 118 and/or the BSP 108 is configured to retrieve the public key and to verify the signature on the session ID. When verified, the authentication service platform 118 and/or the BSP 108 is configured to compare the biometric bound to the public key to the biometric in the request.

When there is a match, the authentication service platform 118 is configured to return a biometric ID, or other suitable data, to the POS terminal 116.

The BSP 108 is configured to repeat the above for each of the signed session IDs. It should be appreciated, however, that of the multiple signed session IDs, only one of the session IDs reveals a public key that is bound to the reference biometric that matches the biometric from the POS terminal 116. That said, the number of session IDs received from the POS terminal 116 may be one, three, five, ten, twenty, etc., or more or less, depending on the first party 102 and the vicinity of the POS terminal 116 to users. The number of users within the range of the POS terminal 116 (which defines the number of signed session IDs), however, is generally far fewer than the total number of reference biometrics in the BSP 108 (e.g., which may be thousands, tens of thousands, or more, etc.).

The POS terminal 116, in turn, is configured to submit a request for authorization of the interaction to the issuers 106, through the PSP 120 and/or the acquirer and processing network 104. In connection therewith, one of the POS terminal 116, the processing network 104, or the issuer 106 is configured to resolve the biometric ID or other data to a primary account number (PAN) specific to the account of the user 112 (issued by the issuer 106 and bound to the biometric). The issuer 106 is configured to approve or decline the transaction, and to return an authorization reply to the POS terminal 116 indicating the approval or the decline.

Additionally, or alternatively, in one or more embodiments, after enrollment, the user 112 travels to first party 102 to purchase one or more products, etc., whereupon, at checkout, the user 112 selects to initiate a biometric interaction (e.g., a biometric checkout (BCO), etc.) at the POS terminal 116 of the first party 102. In response, the POS terminal 116 is configured to broadcast the session ID, via BLE protocol (e.g., in the 2.400-2.4835 GHz ISM band, etc.) or other suitable communication protocol to the vicinity or range of the broadcast of the POS terminal 116 (e.g., within about five ft., about 10 ft., about 30 ft., about 505 ft., etc.). The POS terminal 116 is further configured to scan the one or more products to be purchased by the user 112, to generate a total amount to be funded to complete the purchase.

In connection therewith, the mobile device 110, as configured by the application 114, receives the broadcasted session ID from the POS terminal 116. In turn, the mobile device 110 is configured to request an app attestation assertion from the authentication service platform 118. The authentication service platform 118 is configured to respond with the DRT for the specific mobile device 110. The mobile device 110 is configured to then issue a response to the broadcast from the POS terminal 116, which includes the DRT and the biometric ID, and also the device ID of the specific mobile device 110. It should be appreciated that the POS terminal 116 may receive multiple responses to the broadcast where multiple enrolled mobile devices are within the range of the POS terminal 116. As such, the POS terminal 116 is configured to add each response from each mobile device to a listing of responses. The listing of responses includes, for each response, the biometric ID, the device ID, and the DRT.

In addition to the above, the POS terminal 116 is configured to capture a biometric of the user 112 and to transmit a request for the authentication service platform 118 to resolve the biometric, where the request includes the biometric and the listing of responses from the mobile device 110 (which includes entries that each include the biometric ID, the device ID, and the DRT, etc.). In response to the request, the authentication service platform 118 is configured to cooperate with the BSP 108, based on the biometric ID, the biometric, etc., to identify the user 112.

For example, the authentication service platform 118 is configured to transmit the biometric ID, the biometric, and the liveness data for the biometric to the BSP 108. In response, the BSP 108 is configured to resolve the biometric into a biometric ID (where the search is limited by the inclusion of the biometric ID), and if found, to return the biometric ID (or bspUserID) to the authentication service platform 118. The authentication service platform 118 is configured to then perform a lookup of the device ID based on the DRT. Where there is a match for the DRT, the authentication service platform 118 retrieves the bound device ID. Next, the authentication service platform 118 is configured to verify that the biometric ID and the device ID are bound to one another. When the binding is confirmed, the authentication service platform 118 is configured to generate a proof of authentication, which indicates the multi factor authentication with one factor being a biometric and the other factor being possession of the mobile device 110. The authentication service platform 118 is configured to then retrieve an account reference for one or more of the accounts bound to the biometric ID and the device ID and to submit the account reference to a service of the processing network 104.

The biometric interaction is then initiated by and between the processing network 104, the PSP 120, and the first party 102, based on the proof of authentication and the account credential linked to the biometric ID.

While only one first party 102, one issuer 106, one BSP 108, and one PSP 120 are illustrated in FIG. 1, it should be appreciated that any number of these parts and/or entities (and their associated components) may be included in the system 100, or may be included as a part of systems in other embodiments, consistent with the present disclosure. Likewise, it should be appreciated that the system 100 and/or other system embodiments will generally include numerous users, each associated with an account, a mobile device, and a biometric for use in biometric interactions with the first parties, etc.

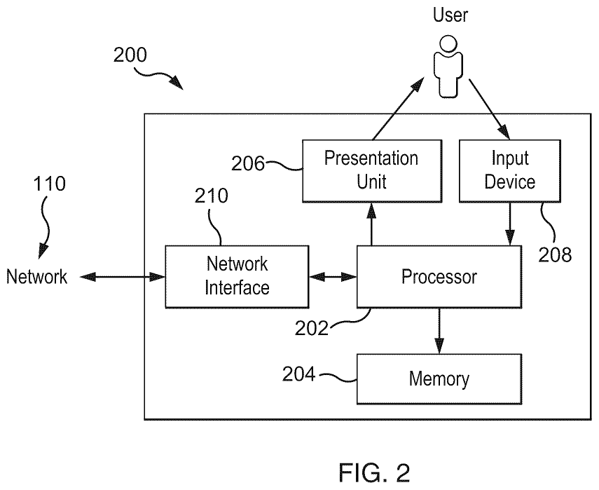

FIG. 2 illustrates an example computing device 200 that may be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to operate as described herein. In the example embodiment of FIG. 1, each of the first party 102, the processing network 104, the issuer 106, the BSP 108, the mobile device 110, POS terminal 116, the PSP 120, and the authentication service platform 118 are understood to be included in, or as being generally implemented in, at least one computing device generally consistent with computing device 200, coupled to (and in communication with) the one or more networks. However, with that said, the system 100 should not be considered to be limited to the computing device 200, as described below, as different computing devices and/or arrangements of computing devices may be used.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, floppy disks, tapes, hard disks, and/or any other type of volatile or nonvolatile physical or tangible computer-readable media. The memory 204 may be configured to store, without limitation, biometric, keys, biometrics IDs, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein, whereby such performance improves operation of the computing device (as described herein) and transforms the computing device 200 into a special-purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, such as requests for biometrics, etc., audibly or visually, for example, to a user of the computing device 200, such as the user 112 in the system 100 (e.g., at the mobile device 110, the POS terminal 116, etc.), etc. The presentation unit 206 may include, without limitation a liquid crystal display (LCD), a light-emitting diode (LED) or LED display, an organic LED (OLED) display, an “electronic ink” display, speakers, etc. In some embodiments, presentation unit 206 may include multiple devices.

In addition, the computing device 200 includes an input device 208 that receives inputs from the user of the computing device 200 (i.e., user inputs) such as, for example, biometric inputs, etc., as further described herein. The input device 208 may include a single input device or multiple input devices. The input device 208 is coupled to (and is in communication with) the processor 202 and may include, for example, a keyboard, a pointing device, a mouse, position sensors, biometric capturing device, or any other type of sensor, a touch sensitive panel (e.g., a touch pad or a touch screen, etc.), another computing device, and/or an audio input device, etc. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., Wi-Fi adapter, a near field communication (NFC) adapter, a Bluetooth adapter, etc.), a mobile network adapter, or other device capable of communicating to one or more different networks, including the one or more networks described above. Further, in some example embodiments, the computing device 200 may include the processor 202 and one or more network interfaces incorporated into or with the processor 202.

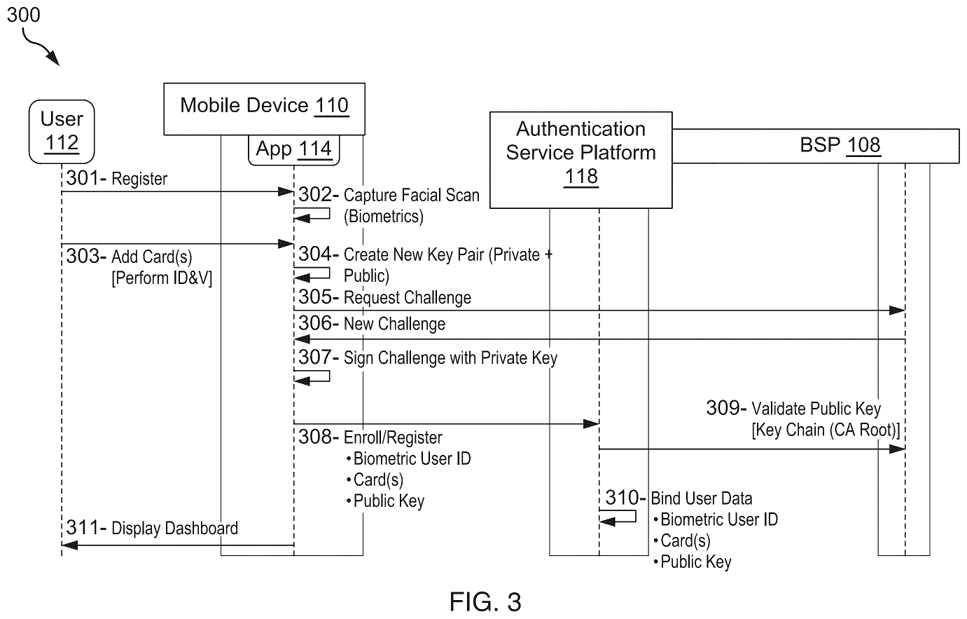

FIG. 3 illustrates an example method 300 for use in enrolling a user for biometric interactions. The example method 300 is generally described in connection with the mobile device 110 and the BSP 108, etc., of the system 100, and in conjunction with the other entities in FIG. 1. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 300.

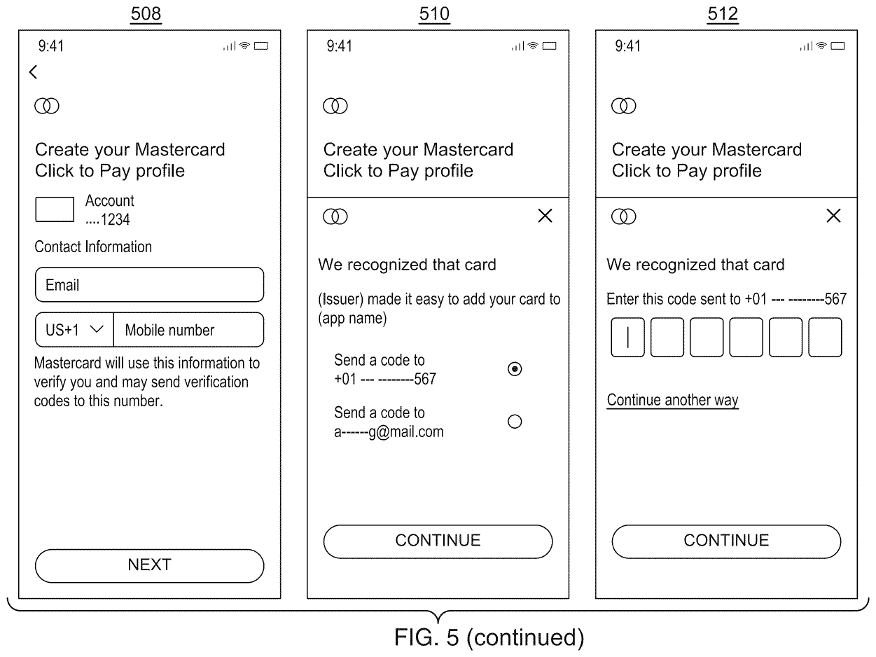

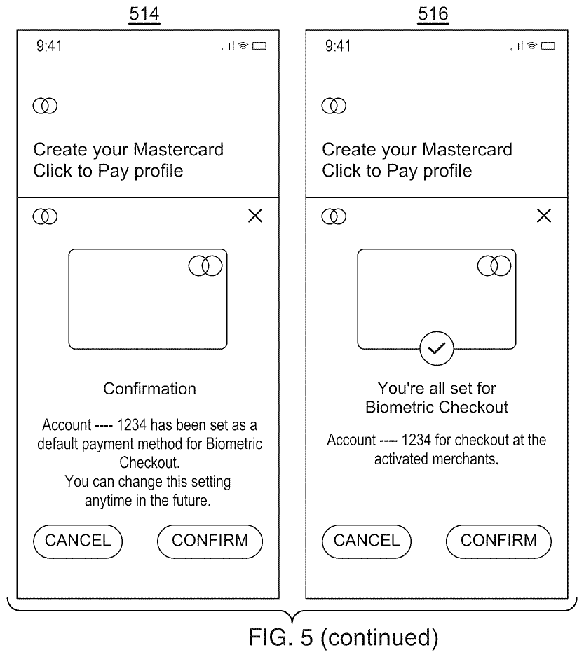

In the method 300, the mobile device 110 is described as performing one or more steps, which should be understood to be the mobile device 110 performing a step and that the step may be understood to be caused by the application 114, or not. In addition, various example interfaces are shown in FIG. 5, which illustrate the method 300. That said, it should be understood that the method 300 is not limited to the interfaces shown in FIG. 5, while, likewise, the interfaces in FIG. 5 are not limited to the method 300.

At the outset, it should be appreciated that the user 112 has downloaded the application 114 to the mobile device 110, and launched the application in the mobile device 110. Thereafter, the user 112 decides to enroll for biometric-initiated pay, generally, whereby the user 112 initiates registration or enrollment, at 301, for biometric interactions. The option to enroll/register is illustrated, for example, in the interface 502 in FIG. 5.

In response, at 302, the mobile device 110 captures a biometric of the user 112, for example, via a biometric capturing device of the mobile device 110, etc. That is, the mobile device 110 may prompt the user 112 to present his/her face to a camera device (e.g., input device 208, etc.) of the mobile device 110 (as shown in the interface 504 in FIG. 5), whereupon the mobile device 110 captures the biometric. As part thereof, the mobile device 110 may perform suitable quality and liveness checks for size of the biometric, clarity of the biometric, etc.

Based thereon, at 303, the user 112 identifies a card account to be linked to the biometric. With reference to FIG. 5, this is shown in the example interface 506. In addition to the card account, the mobile device 110 further requests an email address or phone number associated with the user 112, as shown, for example, in the interface 508 in FIG. 5. In response, the mobile device 110 initiates an ID&V process with the issuer 106 of the card account, through one or more entities. For example, the mobile device 110 may request a one-time-passcode (OTP) from the issuer 106 (e.g., as part of a 3DS ID&V flow, etc.), where the request includes the card account data and the email address or phone number, etc. In connection therewith, the issuer 106 identifies the user 112 based the data provided, and confirms that the email address or phone number are linked to the user 112. Optionally, as shown in the example interface 510 in FIG. 5, the user 112 may select, at the mobile device 110, which mode of communication (e.g., phone or email, etc.) through which to receive the OTP. Based thereon, the issuer 106 (or the processing network 104 depending on the enrollment of the user 112 (e.g., a prior enrollment of the card account, etc.), etc.) then transmits the OTP to the mobile device 110, for example, based on the phone number thereof (e.g., via text message, etc.).

In turn, the mobile device 110 requests the OTP from the user 112. This is shown, for example, in the interface 512 in FIG. 5, whereupon the user 112 enters the OTP to the mobile device 110. The mobile device 110 provides the OTP to the issuer 106 (or the processing network 104), which confirms the OTP to complete the ID&V process. In connection therewith, the mobile device 110 may confirm with the user 112 to make the card account the default account for the biometric, as shown, for example, in interface 514 of FIG. 5.

It should be appreciated that various sequences may be employed to identity and verify the user 112 in connection with enrollment/registration.

Referring again to FIG. 3, after the ID&V is complete, the mobile device 110 creates, at 304, a key pair, which includes a private key and a public key. The private key is stored in a secure element of the mobile device 110. The mobile device 110 then requests a challenge from the BSP 108, at 305, and the BSP 108 responds, at 306, with the challenge. The challenge may include any suitable string of characters, which may be numeric, alpha, or alpha-numeric, for example. In response, at 307, the mobile device 110 retrieves the private key created at step 304 and signs the challenge with the private key. The mobile device 110 then transmits, at 308, as a registration/enrollment request, the signed challenge, the public key, the captured biometric (or biometric template thereof), and the card account data to the authentication service platform 118.

The authentication service platform 118 then validates, at 309, the public key with the BSP 108. In particular, the authentication service platform 118 is configured to provide the signed challenge, and the public key to the BSP 108, along with the biometric and biometric ID. The BSP 108, in turn, is configured to verify the signature on the challenge based on the public key. Once verified, the BSP 108 is configured to create a mapping between the public key, the captured biometric (or template thereof), and the biometric ID and to store the same in memory thereof.

When the validation with the BSP 108 is complete, the authentication service platform 118 binds, at 310, the biometric ID, the card account and the public key and stores the same in memory thereof. In connection with the above, the mobile device 110 displays, at 311, an interface, or dashboard, etc., to the user 112, which indicates the successful enrollment/registration. The example interface 516 in FIG. 5 illustrates the message to the user 112 that the user 112 is enrolled/registered for biometric interactions.

It should be understood that the mobile device 110 may further provide options for the user 112 to select certain merchants (e.g., opt in, etc.), for which the biometric interactions are permitted or activated (whereby biometric interactions would not be permitted at other merchants). The preference may be communicated to the authentication service platform 118 and/or the BSP 108, whereby either is configured to enforce the preference for subsequent transactions.

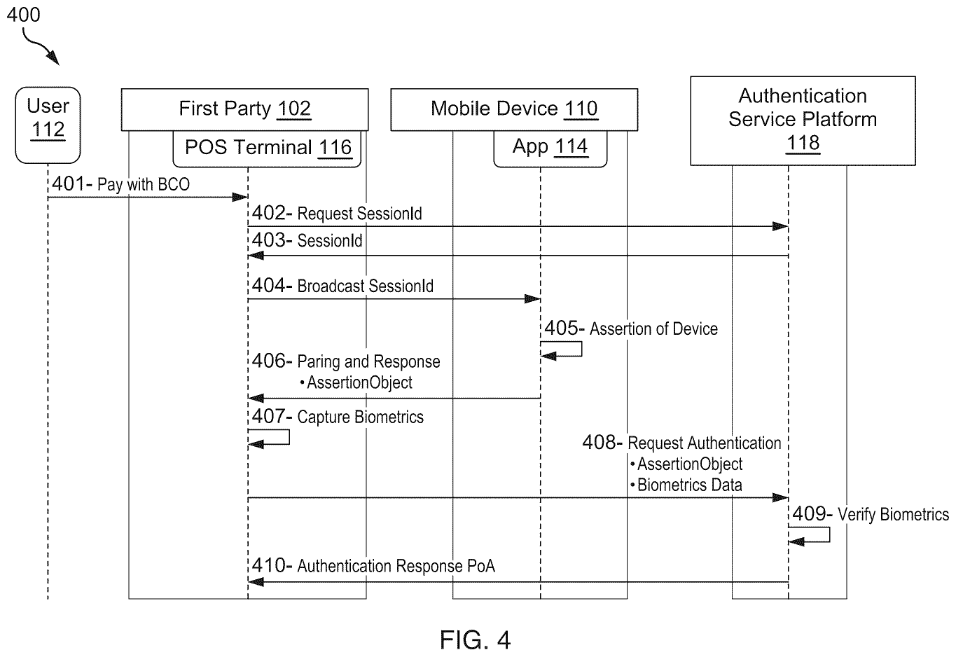

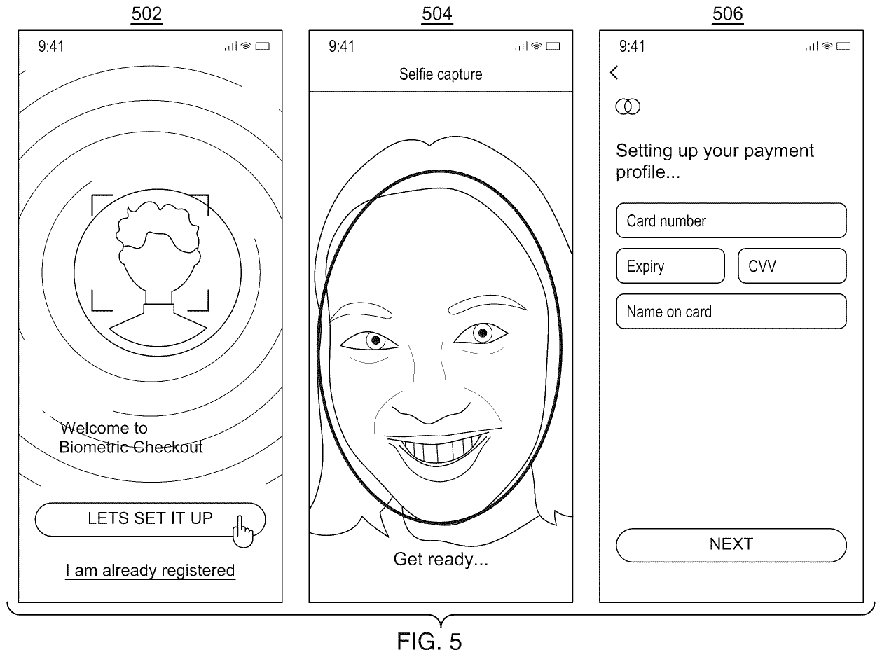

FIG. 4 illustrates an example method 400 for use in initiating a biometric interaction for payment to one or more first parties. The example method 400 is generally described in connection with the first party 102, the BSP 108, the mobile device 110, and the authentication service platform 118 of the system 100, and in conjunction with the other entities in FIG. 1. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 400.

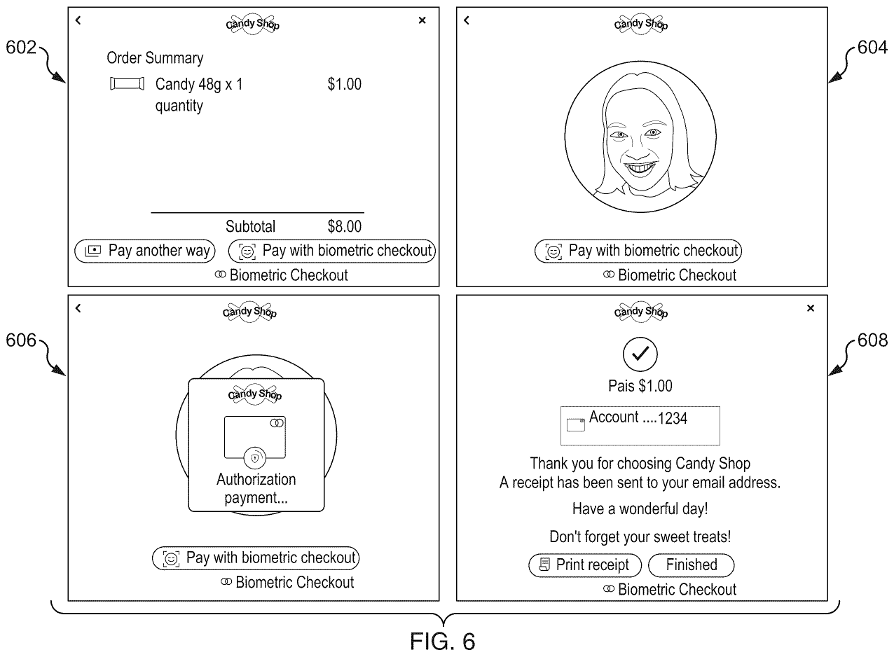

In addition, various example interfaces are shown in FIG. 6, which illustrate the method 400. That said, it should be understood that the method 400 is not limited to the interfaces shown in FIG. 6, while, likewise, the interfaces in FIG. 6 are not limited to the method 400.

Subsequently, after enrollment, the user 112 travels to first party 102 to purchase one or more products, etc., whereupon, at checkout, the user 112 selects, at 401, at the POS terminal 116, to initiate a biometric interaction (e.g., a biometric checkout (BCO), etc.) with the first party 102. This is illustrated, for example, in the interface 602 in FIG. 6, in which the lower right button in blue provides for a biometric interaction.

In response, at 402, the POS terminal 116 requests a session ID for the transaction from the BSP 108. In turn, the BSP 108 generates a unique session ID for the transaction and, at 403, returns the session ID to the POS terminal 116. Upon receipt of the session ID, the POS terminal 116 is configured to broadcast, at 404, the session ID, in a manner receivable by devices within a range of the POS terminal 116. In particular, the POS terminal 116 is configured to broadcast (e.g., by the network interface 210, etc.), via a Bluetooth Low Energy (BLE) protocol (e.g., in the 2.400-2.4835 GHz ISM band, etc.), etc., to one or more mobile devices, including the mobile device 110, which are within a range of the broadcast.

In this example embodiment, the mobile device 110 is within the range of the POS terminal 116, and consequently, the mobile device 110 receives the session ID (because it is enrolled) and generates a device assertion (e.g., an assertion object, etc.), at 405. This includes, in this embodiment, signing the session ID with the private key (created during enrollment). The mobile device 110 then returns, at 406, the signed session ID to the POS terminal 116. The session ID, because it is signed, includes metadata specific to the mobile device 110.

Given the range of the broadcast, it is possible that additional mobile device, similar to the mobile device 110, received the session ID. Each, consequently, signs the session ID and returns the signed session ID as an attestation object to the POS terminal 116. It should be appreciated that each signature is distinct because each private key for each mobile device is also distinct.

With continued reference to FIG. 4, the POS terminal 116 then captures, at 407, a biometric of the user 112. As shown, for example, in the interface 604 in FIG. 6, the user 112 is prompted to present his/her face to the POS terminal 116, whereby the biometric is captured. The POS terminal 116 may, optionally, generate a biometric template from the captured biometric. At 408, the POS terminal 116 transmits a request for the authentication service platform 118 to resolve the biometric, where the request includes the biometric (e.g., captured biometric and/or template thereof, etc.) and each of the signed session IDs.

In response to the request, the authentication service cooperates with the BSP 108 to verify the biometric, at 409. That is, the authentication service platform 118 reads the signed session ID (e.g., signature, etc.) for metadata indicative of the mobile device that signed the session ID. The metadata may include a specific identifier or other information, from which the BSP 108 is configured to identify a public key specific to the mobile device 110. The authentication service platform 118 retrieves the public key and verifies the signature on the session ID. When verified, the authentication service platform 118, alone or in cooperation with the BSP 108, then compares the reference biometric bound to the public key to the biometric in the request.

When there is a match, the authentication service platform 118 returns, at 410, a biometric ID, or other suitable data, to the POS terminal 116.

The authentication service platform 118 repeats the above for each of the signed session IDs, which are based on the same session ID from the authentication service platform 118. It should be appreciated, however, that of the multiple signed session IDs (i.e., same session ID signed with different public keys), only one of the session IDs reveals a public key bound to a matching reference biometric.

The POS terminal 116, in turn, submits a request for authorization of the interaction to the issuer 106, through the PSP/acquirer and processing network 104. In connection therewith, one or more of the POS terminal 116, the processing network 104, or the issuer 106 resolves the biometric ID or other data to a primary account number (PAN) specific to the card account of the issuer 106. The issuer 106 approves or declines the transaction, and returns an authorization reply to the POS terminal 116 indicating the approval or the decline.

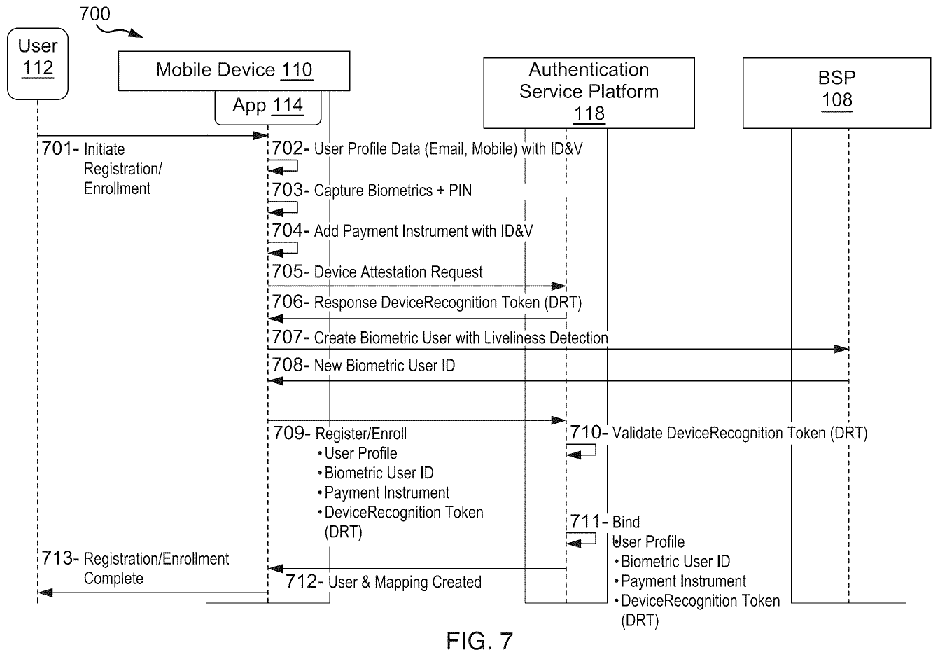

FIG. 7 illustrates an example method 700 for use in enrolling a user for biometric interactions. The example method 700 is generally described in connection with the mobile device 110 and the BSP 108, etc., of the system 100, and in conjunction with the other entities in FIG. 1. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 700.

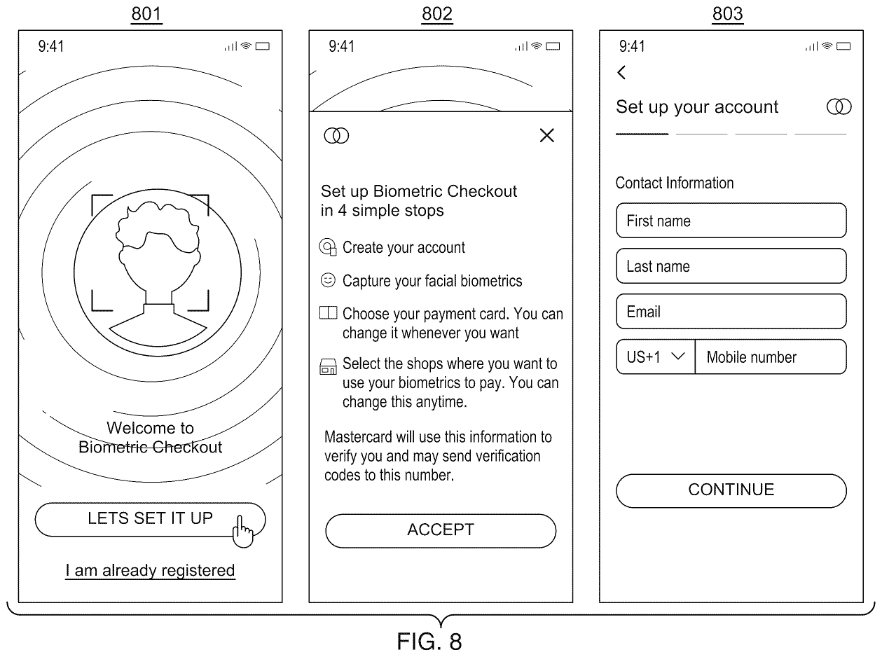

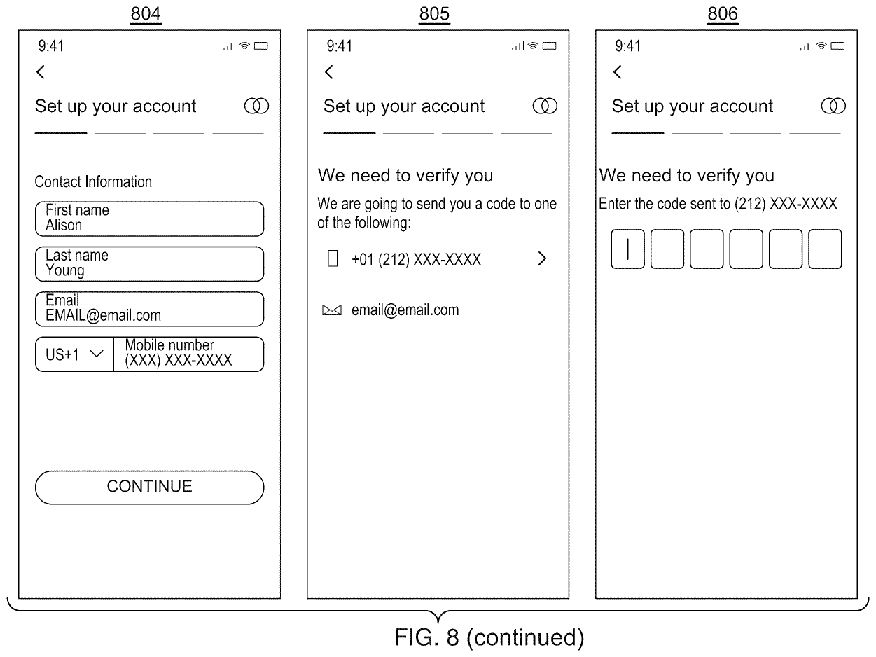

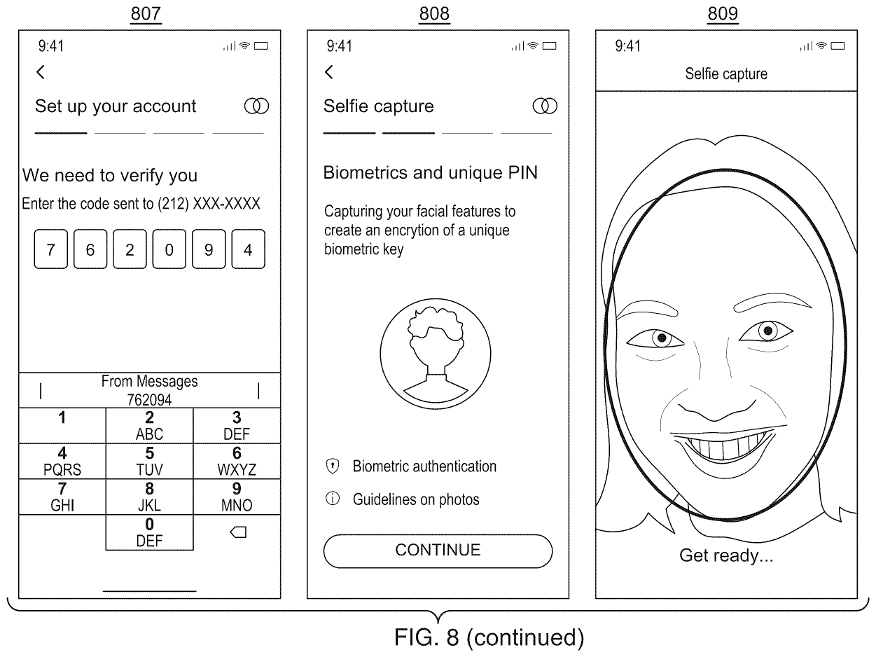

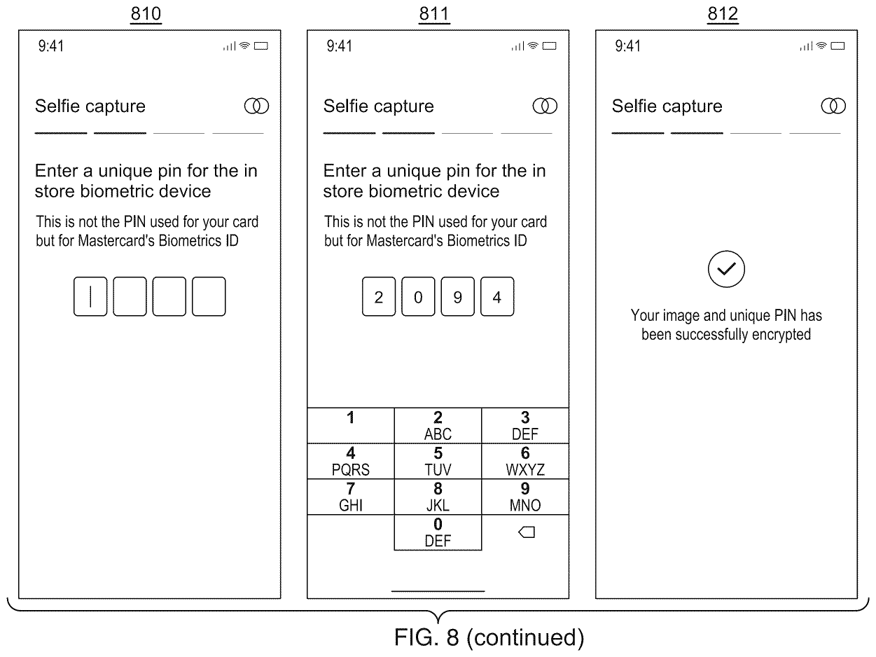

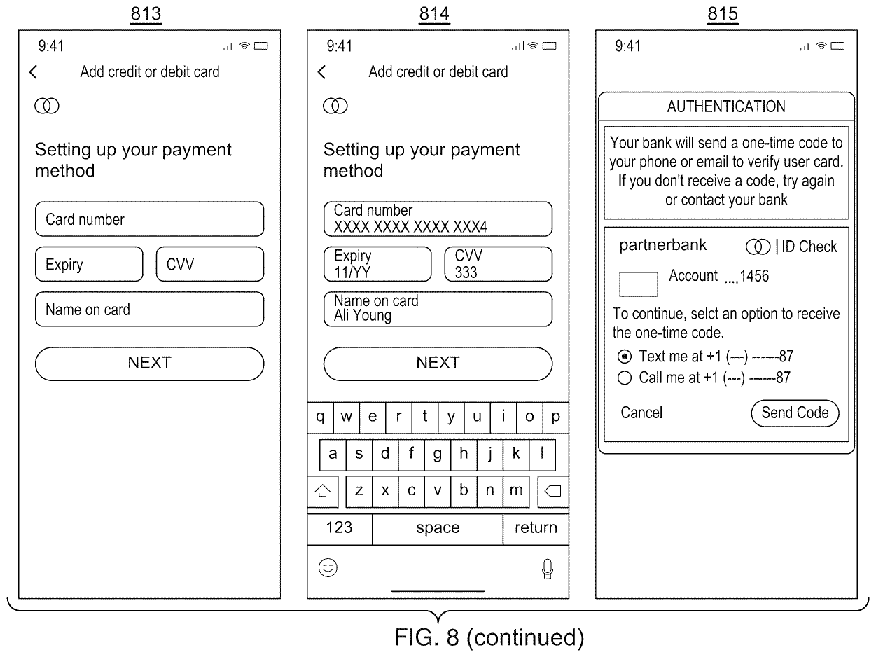

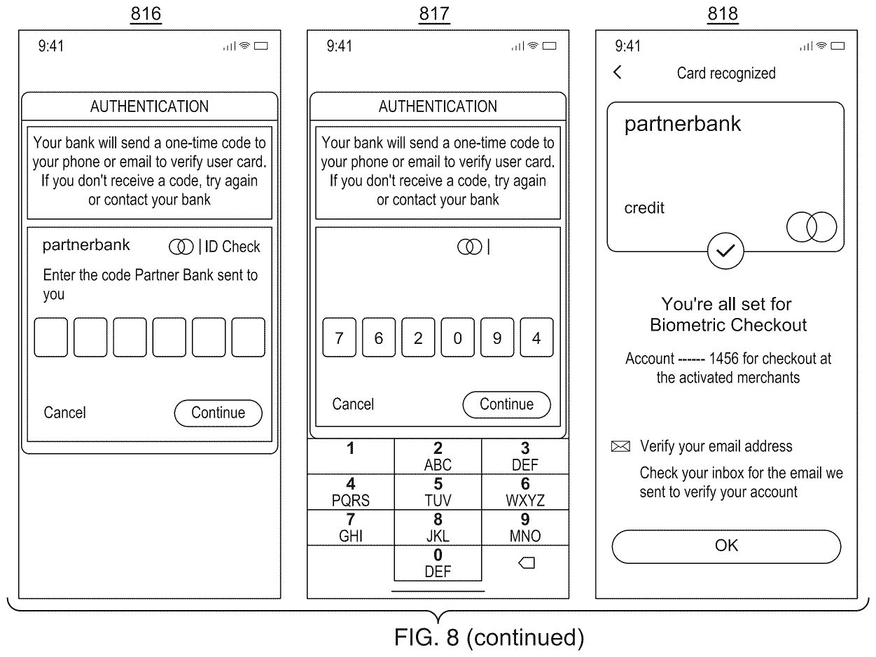

In the method 700, the mobile device 110 is described as performing one or more steps, which should be understood to be the mobile device 110 performing a step and that the step may be understood to be caused by the application 114, or not. In addition, various example interfaces 801-818 are shown in FIG. 8, which illustrate the method 700. That said, it should be understood that the method 700 is not limited to the interfaces 801-818 shown in FIG. 8, while, likewise, the interfaces 801-818 in FIG. 8 are not limited to the method 700.

At the outset, it should be appreciated that the user 112 has downloaded the application 114 to the mobile device 110, and launched the application in the mobile device 110. Thereafter, the user 112 decides to enroll for biometric-initiated pay, generally, whereby the user 112 initiates registration or enrollment, at 701, for biometric interactions.

The option to enroll/register is illustrated, for example, initially in the example interface 801 in FIG. 8 for the user 112 and then also at example interface 802, in which the user 112 is informed about one or more advantages of the option of biometric interactions.

In response, at 702, the mobile device 110 solicits and receives, from the user 112, identifying data for the user 112 to enroll the user 112, where the identifying data includes a name and an email address or a mobile phone number. The example interface 803 illustrates the mobile device 110 soliciting the identifying data, and the example interface 804 illustrates the entry of the identifying data by the user 112. In response, the mobile device 110, alone or in combination with a backend, communicates a one-time-passcode (OTP) to the user 112, to the email address or the phone number, as part of an identity and verification (ID&V) process. As shown in FIG. 8, the mobile device 110 solicits a selection between the email address and the mobile phone number from the user 112, for example, through the example interface 805. In response to a selection, the OTP is sent, whereupon the user 112 receives the OTP at the mobile device 110. The mobile device 110 solicits the OTP from the user 112 through the example interface 806. The user 112 then inputs the OTP to the mobile device 110, and in particular, the application 114, through the example interface 807. The example interfaces 806, 807 illustrate the mobile device 110 soliciting the OTP from the user 112 and receiving the OPT therefrom.

With reference again to FIG. 7, the mobile device 110 then captures a biometric and a PIN from the user 112, at 703.

In particular, as shown in FIG. 8, the example interface 808 is displayed at the mobile device 110 to introduce the capture of the biometric and the PIN. Based on an input from the user 112 to select to continue, the example interface 809 is shown at the mobile device 110. In connection therewith, a camera device of the mobile device 110 is activated to capture a selfie of the user 112. As instructed by the example interface 809, the user 112 moves the mobile device 110 relative to his/her face (i.e., frames the face with a reference oval in the interface 809), whereupon the mobile device 110 captures the biometric of the user 112. It should be appreciated that in connection with capturing the biometric of the user 112, the mobile device 110 imposes one or more checks on the biometric being captured, including, for example, liveness detection to ensure a live person is being presented to the camera device.

In the example interface 810, the mobile device 110 solicits a PIN from the user 112. In response, the user 112 enters the PIN to the mobile device 110, via the touchpad shown in example interface 811. Based on the entry from the user 112, the mobile device 110 receives the PIN. In addition, in this example embodiment, the mobile device 110 encrypts the captured biometric and the entered PIN. When the PIN is received, and the selfie or other biometric is captured, the example interface 812 is displayed at the mobile device 110 to indicate the successful capture of the PIN and the biometric (and checks related thereto).

With reference again to FIG. 7, at 704, the mobile device 110 adds one or more payment accounts for use in biometric interactions. In particular, as shown in FIG. 8, the mobile device 110 solicits account information from the user 112, through the example interface 813. In turn, the user 112 enters the account information, for example, through the example interface 814.

Although not shown in FIG. 7, the mobile device 110 interacts with the issuer of the account identified by the user 112. Based thereon, the issuer 106, for example, interacts with the user 112, through the mobile device 110 (e.g., through an issuer application in the mobile device 110, or an integration of the issuer 106 with the application 114 (e.g., via SDK, directly, or through the authentication service platform 118). In connection therewith, the mobile device 110 displays example interface 815 to the user 112, which solicits contact preferences of the user 112 to be identified and verified with the issuer 106. In response the user 112 selects a contact preference in the example interface 815, for example, whereupon the issuer 106 generates and transmits an OTP consistent with the preference of the user 112, to the user 112 (e.g., at the mobile device 110). Next, the mobile device solicits the OTP from the user 112, for example, as shown in example interface 816. Upon receipt of the OTP at the mobile device 110 (or another device), the user 112 enters the OTP to the mobile device 110, for example, through the example interface 817 as shown in FIG. 8, whereby the OTP is submitted, through the mobile device 110 to the issuer 106. When the OTP is verified, the issuer 106 notifies the mobile device 110 of the completed identify and verify process, for example, as shown in the example interface 818, whereupon the account identified by the user 112 is available for biometric interactions.

It should be appreciated that the steps associated with interfaces 812-818 may be repeated multiple times to add multiple accounts for biometric interactions.

With reference again to FIG. 7, at 705, the mobile device 110 provides an attestation request to the authentication service platform 118. The request includes a signature specific to the mobile device 110 (e.g., based on a key included therein, as described above). In response, the authentication service platform 118 generates and returns a device recognition token (DRT) to the mobile device 110.

What's more, as shown, the mobile device 110 submits, at 707, the biometric of the user 112 to the BSP 108, as a request for a biometric ID for the biometric to be provided. It should be appreciated that the request includes an indication of the one or more checks performed in capturing the biometric (e.g., the liveness detection, etc.). In response, the BSP 108 validates the biometric and check(s), generates a biometric ID (also referred to as a bspUserID), binds the biometric to the biometric ID, and then issues a biometric ID for biometric to the user 112, at 708.

At 709 in FIG. 7, the mobile device registers the user 112 with the authentication service platform 118. The registration data includes the user profile (e.g., name, mobile number, email address, device ID for the mobile device 110, etc.), the biometric user ID, the payment account(s) and the DRT. In response, the authentication service platform 118 validates, at 710, the DRT. The validation may include, for example, matching the DRT to the DRT provided at step 706. The matching may be based on a device ID associated with the mobile device 110 and included in the registration data, etc. When the DRT is validated, the authentication service platform 118 binds the user profile (including the device ID for the mobile device 110), the biometric user ID, the payment account(s), and the DRT, at 711. Binding generally refers to linking the specific data so that, for example, the account(s) is/are only accessible when a DRT and biometric are presented that match the DRT and biometric bound to the account(s) at the authentication service platform 118, as explained in more detail below.

Once bound, at 712, the authentication service platform 118 returns a confirmation, to the mobile device 110, that a mapping (or binding, etc.) between the user profile, the biometric user ID, the payment instrument, and the DRT has been created, and is ready to be used to authenticate the user 112 (e.g., for in-store checkout payments, etc.).

In connection with the above, the mobile device 110 displays, at 713, an interface, or dashboard, etc., to the user 112, which indicates the successful enrollment/registration. The example interface 818 in FIG. 8 illustrates the message to the user 112 that the user 112 is enrolled/registered for biometric interactions.

It should be understood that the mobile device 110 may optionally provide options for the user 112 to select certain merchants (e.g., opt in, etc.), for which the biometric interactions are permitted or activated (whereby biometric interactions would not be permitted at other merchants). The preference may be communicated to the authentication service platform 118 and/or the BSP 108, whereby either is configured to enforce the preference for subsequent transactions.

FIG. 9 illustrates an example method 900 for use in initiating, by a user, a biometric interaction with one or more first parties. The example method 900 is generally described in connection with the first party 102, the BSP 108, the mobile device 110, and the authentication service platform 118 of the system 100, and in conjunction with the other entities in FIG. 1. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 900.

In addition, various example interfaces are shown in FIG. 6, which illustrate the method 900. That said, it should be understood that the method 900 is not limited to the interfaces shown in FIG. 6, while, likewise, the interfaces in FIG. 6 are not limited to the method 900.

Subsequently, after enrollment, the user 112 travels to first party 102 to purchase one or more products, etc., whereupon, at checkout, the user 112 selects, at 901, at the POS terminal 116, to initiate a biometric interaction (e.g., a biometric checkout (BCO), etc.) with the first party 102 to fund the purchase of the one or more products. This is illustrated, for example, in the interface 602 in FIG. 6, in which the lower right button provides for a biometric interaction or “Pay with biometric checkout.”

In response, at 902, the POS terminal 116 broadcasts the session ID, via BLE protocol (e.g., in the 2.400-2.4835 GHz ISM band, etc.) or other suitable communication protocol to the vicinity or range of the broadcast of the POS terminal 116 (e.g., within about five ft., about 10 ft., about 30 ft., about 100 ft., about 505 ft., etc.). It should be appreciated that the session ID may be generated by the POS terminal 116, or retrieved from the processing network 104. The POS terminal 116 then proceeds to scan, at 903, the one or more products to be purchased by the user 112. In this manner, the POS terminal 116 identifies each of the one or more products, and compiles details of the checkout including the amount of the interaction, etc.

In the meantime (or before or after), each of the mobile devices in the vicinity, including, specifically, the mobile device 110, receives the broadcasted session ID from the POS terminal 116. In turn, the mobile device 110 (and each other mobile device) requests, at 904, a device assertion from the authentication service platform 118. The authentication service platform 118 responds, at 905, to the requests with the DRT for the specific mobile device 110. Specifically, for example, the authentication service platform 118 identifies the mobile device 110 based on a device ID or other suitable ID (e.g., application ID, phone number, email address, etc.) for the mobile device 110 from the user profile for the user 112 (and for the mobile device 110 from the registration/enrollment thereof). The authentication service platform 118 then retrieves the DRT specific to the mobile device 110 and an identifier of the BSP 108, which was used during registration/enrollment, and then, returns, at 905, the same to the mobile device 110. In turn, at 906, the mobile device 110 (and each other mobile device) issues a response to the broadcast from POS terminal 116, which includes the DRT and the biometric ID or bspUserID, and also the device ID of the specific mobile device (which are broadcast back to the POS terminal 116). It should be appreciated that the data, in whole or in part, may further be signed by a private key of the mobile device 110, as necessary or desired.

Like above, given the range of the broadcast, it should be appreciated, therefore, that the POS terminal 116 receives at least one response to the broadcast (i.e., the broadcasted response from the mobile device 110), and potentially multiple responses to the broadcast depending on the number of enrolled/registered mobile devices within the vicinity of the POS terminal 116. As such, at 907, the POS terminal 116 adds each response from each mobile device to a listing of responses. The listing of responses includes, for each response, the biometric ID, device ID, and the DRT.

In addition to the above, the POS terminal 116 captures, at 908, a biometric of the user 112. As shown, for example, in the interface 604 in FIG. 6, the user 112 is prompted to present his/her face to the POS terminal 116, whereby the biometric is captured. The POS terminal 116 may, optionally, generate a biometric template from the captured biometric. At 909, the POS terminal 116 transmits a request for the authentication service platform 118 to resolve the biometric, where the request includes the biometric (e.g., captured biometric and/or template thereof, etc.) and the listing of responses from the mobile devices (which includes entries each including the biometric ID, the device ID, and the DRT, etc.). It should be appreciated that in various examples the session ID may be used to identify the interaction, whereby the authentication service platform 118 accesses and uses the session ID in a similar manner to which the session ID is accessed and used in other embodiments herein (e.g., identify the user 112 based on the public key, which is usable with the signed session ID, etc.). It should be understood then that the session ID is used herein to support biometric checkout, as multiple biometric checkout interactions may be in process at the same time at multiple POS terminals at the location. As such, the session ID is used to distinguish the specific interaction and to map the broadcast responses from the nearby devices to the biometric interaction initiated at the specific POS terminal 116 (identified also by the session ID).

In response to the request, the authentication service platform 118 cooperates with the BSP 108, based on the biometric ID to identify the user 112.

That is, for example, at 910, the authentication service platform 118 identifies the BSP 108 and transmits the biometric ID, the biometric and the liveness data for the biometric to the BSP 108. In response, the BSP 108 resolves the biometric into a biometric ID bound to a matching biometric template (e.g., where the search is limited by the inclusion of the biometric ID from the requests, or based on the public key associated with the signed session ID, etc.), if found, and returns, at 911, the biometric ID (or bspUserID) to the authentication service platform 118. The authentication service platform 118 performs, at 912, a lookup of the device ID based on the DRT. Where there is a match for the DRT, the authentication service platform 118 retrieves the bound device ID.

Next, the authentication service platform 118 verifies, at 913, that the biometric ID and the device ID are bound to one another (e.g., as explained in step 711, etc.).

When the binding is confirmed, the authentication service platform 118 seamlessly generates, at 914, a proof of authentication, which indicates the multi-factor authentication with one factor being a biometric and the other factor being possession of the mobile device 110. The authentication service platform 118 then retrieves an account reference for one or more of the accounts bound to the biometric ID and the device ID. It should be understood that the account reference includes, in this embodiment, a token for the specific account (i.e., the token is linked to the account credential (e.g., primary account number (PAN), expiration date, etc.) for the account rather than being the account credentials for the account). In particular, in this example, the token includes a Secure Card on File (SCoF) token, which represents a unique digital identifier that replaces a stored primary account number (PAN) for certain e-commerce interactions. In connection therewith, the SCoF token may be generated by the processing network 104 or other entity within the scope of the present disclosure. That said, it should be appreciated that other payment instruments/tokens may be employed to represent other forms of payment (beyond the FPAN), such as, for example, bank accounts, crypto wallets, or other forms of payment, etc.

The token is submitted, at 915, by the authentication service platform 118 to the SRC of the processing network 104. The SRC returns, at 916, a request for a transaction payload to the token to the authentication service platform 118.

In connection therewith, the authentication service platform 118 requests, at 917, a transaction payment from the first party 102, and specially, the POS terminal 116. The POS terminal 116 compiles the transaction payload, including, the amount, first party details, etc. Alternatively, in some example embodiments, the processing network 104 may compile the transaction payload, including, the amount, first party details, etc. (instead of transmitting the request to the first party 102).

From there, FIG. 9 illustrates multiple alternative paths for the transaction payload (following transmittal of the request to the first party 102) for an authorization payment end flow.

Initially, the transaction payload request includes the account credential for the account of the user 112 to fund the transaction. Consequently, when the first party 102 compiles the transaction payload, the transaction payload includes the credential along with the other details of the interaction. The first party 102 then submits the transaction payload (as a request for the interaction (or transaction)) to the PSP 120, at 918, whereupon the PSP 120 initiates the transaction and provides a transaction result, at 919. The POS terminal 116, in turn, displays the transaction result, at 920, indicating, in this example, that the transaction has been successfully completed.

Alternatively, the first party 102, or more specifically, the POS terminal 116, may return the transaction payload to the checkout service of the processing network 104, as indicated at 918a. The checkout service of the processing network 104 then completes the transaction payload with the account credential of the user's account, and submits, at 918b, the transaction payment to the PSP, at 918b. The PSP initiates the transaction and provides a transaction result, at 919a, to the checkout service. The checkout service of the processing network 104 then provides, at 919b, the transaction result to the POS terminal 116. The POS terminal 116, in turn, displays the transaction result, at 920, indicating, in this example, that the transaction has been successfully completed.

In yet another example, step 917 is omitted. That is, the first party 102 provides sufficient information to the processing network 104 in a prior step (e.g., the step 909, etc.), whereby upon verification at step 913 and requesting the payload at step 915, the processing network 104 (and in particular, the SRC computing device thereof) proceeds to submit the transaction payment to the PSP, at 918, whereupon the PSP initiates the transaction and provides a transaction result, at 919. That is, the POS terminal 116 will send a request, which includes the authentication data (e.g., facial biometric template and list of nearby devices (or a PIN if no device is found), transaction details (e.g., amount, currency, and related information), and associated identifiers (e.g., PSP identifier, merchant ID, etc.) (e.g., at step 909). The processing network 104 then performs the associated steps in response t the request, including biometric matching at step 910, through matching the device information to a payment account, through step 914. Next, at steps 915 and 916, the processing network 104 generates an authorization payload (including a cryptogram) required for the payment transaction. Then, instead of returning this payload to the POS terminal 116 at step 917, the processing network 104 processes the request on behalf of the first party 102 by submitting it directly to their Payment Service Provider (PSP) and return the final result, thereby omitting steps 917 and 918, initiated by the first party 102. In this way, the method includes a simplified, streamlined sequence for the first party 102.

In view of the above, the systems and methods herein leverage a secure session ID, which is signed by a mobile device associated with a user, and/or the DRT, along with a captured biometric (or template thereof) for the user, to facilitate biometric interaction. In this way, the mobile device of the user, whose biometric is being presented for the interaction, is used to sign the session ID, and/or to identify the DRT to the specific mobile device, which provides a second factor of authentication of the specific user. The use of the signed session ID and/or the DRT, in combination with the biometric, therefore provides two-factor authentication of the user, i.e., the biometric and the mobile device, for the interaction.

What's more, by leveraging the signed session ID and/or the DRT included with the captured biometric (or template thereof), the scope of search for a biometric reference that matches the user initiating the interaction is significantly limited. That is, where the BSP includes thousands, or hundreds of thousands, or more, biometric reference, the search is limited to the number of enrolled users within a range of the session ID broadcast, resulting in searching less than approximately 0.001 percent of biometric references. This is a real and substantial reduction in usage of processing resources (e.g., by the authentication service platform and/or the biometric service provider, etc.) to perform the specific match for the biometric interaction.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art, that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for enhanced biometric authentication, based on proximity of mobile devices, the method comprising:
for a biometric-initiated transaction, receiving, by a computing device, an authentication request from a first party, the authentication request including a biometric specific to a user and captured at a point-of-sale (POS) terminal at the first party and a listing of at least one token and at least one identifier, each of the at least one token associated with only one of the at least one identifier;
identifying at least one biometric template based on the at least one identifier and matching the biometric to each of the at least one biometric templates;
identifying, by the computing device, a device ID of a mobile device, based on the at least one token;
verifying, by the computing device, that the device ID is bound to the at least one identifier, for which the associated biometric template matches the biometric in the authentication request;
compiling, by the computing device, a response to the authentication request, which indicates the user is authenticated, along with an account credential associated with an account of the user;
providing a transaction payload for the transaction to a payment service provider (PSP), the transaction payload including the account credential and an amount of the biometric-initiated transaction, whereby the biometric-initiated transaction is authorized.

2. The computer-implemented method of claim 1, wherein the authentication request include liveness data indicative of a liveness of the user when the biometric was captured at the POS terminal; and
further comprising verifying the liveness data, prior to compiling the transaction payload.

3. The computer-implemented method of claim 1, wherein the listing includes a plurality of tokens and a plurality of identifiers.

4. The computer-implemented method of claim 1, wherein the at least one identifier includes a session ID, which is signed by the mobile device, using a private key specific to the mobile device.

5. The computer-implemented method of claim 4, wherein identifying the at least one biometric template includes identifying the at least one biometric template based on a public key specific to the mobile device, the public key corresponding to the private key used to sign the session ID.

6. The computer-implemented method of claim 1, wherein the at least one identifier includes at least one biometric ID; and
wherein identifying the at least one biometric template includes identifying the at least one biometric template based on the at least one biometric template being associated with the at least one biometric ID.

7. The computer-implemented method of claim 1, wherein the response to the authentication request includes a proof of authentication, which indicates multi-factor authentication of the user; and
wherein providing the transaction payload includes forwarding, by the computing device, an authorization request to the PSP.

8. A computer-implemented method for enhanced biometric authentication, based on proximity of mobile devices, the method comprising:
receiving, by a computing device, a request for a biometric interaction;
requesting, by the computing device, a session ID from an authentication service computing device, the session ID being unique to the biometric interaction;
receiving, by the computing device, the session ID from the authentication service computing device;
broadcasting, by the computing device, the session ID, via a wireless adapter, the broadcast having a range of less than 200 meters;
receiving, by the computing device, at least one response, which includes a signed session ID, in response to the broadcasted session ID;
capturing a biometric of a user associated with the request for the biometric interaction; and
transmitting, by the computing device, the biometric and the signed session ID to the authentication service computing device, whereby the biometric is resolved and the signed session ID is verified.

9. The computer-implemented method of claim 8, wherein the computing device is a point-of-sale (POS) computing device.

10. The computer-implemented method of claim 9, wherein broadcasting the session ID includes broadcasting the session ID through a Bluetooth Low Energy (BLE) protocol network adaptor of the POS computing device; and
wherein the range is about 100 meters.

11. The computer-implemented method of claim 8, wherein receiving at least one response includes receiving multiple responses, each including a distinct signed session ID; and
wherein transmitting the signed session ID includes transmitting multiple distinct signed session IDs from the multiple responses.

12. The computer-implemented method of claim 8, wherein the biometric includes a facial image of the user.

13. The computer-implemented method of claim 8, further comprising enrolling the user for biometric interactions, prior to receiving the request for the biometric interaction.

14. The computer-implemented method of claim 8, further comprising:
signing, by the mobile device, the session ID with a private key from a secure memory of the mobile device; and
returning the session ID to the computing device; and
wherein the signed session ID is verified by a public key corresponding to the private key.

15. The computer-implemented method of claim 8, further comprising enrolling the user for biometric interactions, prior to receiving the request for the biometric interaction.

16. A non-transitory computer-readable storage medium comprising executable instructions, which when executed by at least one processor, cause the at least one processor to:
for a biometric-initiated transaction, receive an authentication request from a first party, the authentication request including a biometric specific to a user and captured at a point-of-sale (POS) terminal at the first party and a listing of at least one token and at least one identifier, each of the at least one token associated with only one of the at least one identifier;
identify at least one biometric template based on the at least one identifier;
match the biometric to each of the at least one biometric templates;
identify a device ID of a mobile device, based on the at least one token;
verify that the device ID is bound to the at least one identifier, for which the associated biometric template matches the biometric in the authentication request;
based on the verified binding between the device ID and the identifier, compile a response to the authentication request, which indicates the user is authenticated, along with an account credential associated with an account of the user;
provide a transaction payload for the transaction to a payment service provider (PSP), the transaction payload including the account credential and an amount of the biometric-initiated transaction, whereby the biometric-initiated transaction is authorized.

17. The non-transitory computer-readable storage medium of claim 16, wherein the listing includes a plurality of tokens and a plurality of identifiers.

18. The non-transitory computer-readable storage medium of claim 16, wherein the at least one identifier includes at least one biometric ID; and
wherein the executable instructions, when executed by the at least one processor, cause the at least one processor, in identifying the at least one biometric template, to identify the at least one biometric template based on the at least one biometric template being associated with the at least one biometric ID.

19. The non-transitory computer-readable storage medium of claim 16, wherein the biometric includes a facial image of the user.
